(19) United States
(12) Patent Application Publication
(10) Pub. No.: US 2007/0211916 A1
(43) Pub. Date: Sep. 13, 2007

(54) Method Of Detecting A Target With A Cfar Thresholding Function Using Clutter Map Entries

(76) Inventors: Iain Baird Smith, Scotland (GB); Adrian Thomas Shalley, Worcestershire (GB); Adrian Britton, Worcestershire (GB); Samantha Jane Lycett, Worcestershire (GB); Michael Andrew Evans, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/593,456

(22) PCT Filed: Mar. 22, 2005
(86) PCT No.: PCT/GB05/01060

§ 371 Date: Sep. 19, 2006

(30) Foreign Application Priority Data
Mar. 27, 2004 (GB) 0406935.7

(51) Int. Cl. G06K 9/00

(52) U.S. Cl. 382/103

(57) ABSTRACT

A method of detecting a target in a scene comprises the steps of (a) obtaining a first data set of data elements which correspond to returns from different parts of the scene; and (b) determining a detection threshold for a part of the scene by reference to data elements corresponding to returns to neighbouring parts of the scene; characterized in that (i) the method further comprises the steps of (c) obtaining a second data set of data elements which correspond only to clutter returns from different parts of the scene; and (d) identifying clutter returns in the first data set by comparing the first and second data sets; and (ii) in step (b), data elements identified in step (d) as corresponding to clutter returns are discounted in determining the detection threshold. The method provides for improved target detection the presence of clutter.

The invention relates to methods of detecting targets, particularly (although not exclusively) by use of a radar or similar system.

One application of radar systems is in the field of security and surveillance, for example perimeter surveillance, intruder detection, area monitoring etc., in which detection of targets is required. Examples of radar systems for performing these types of functions are described in U.S. Pat. Nos 4,595,924 and 6,466,157 and in published U.S. patent application Ser. No. 2002/0 060 639.

Several methods of improving target detection by processing of radar data are known, however the amount of processing that can be done on signals from a low-cost radar system is somewhat limited. One such method, suitable for low-cost radar systems arranged to detect targets within an area under observation, is CFAR (constant false-alarm rate) processing. In a typical implementation of CFAR processing, a rectangular window is scanned over a pixellated map of returns produced by a radar system and a detection threshold is set for each pixel in the map by reference to returns corresponding to pixels within a reference group of pixels containing a particular pixel under consideration, based on an assumed clutter distribution for the area under observation. Typical choices for the assumed clutter distribution are Rayleigh, exponential and K-distributions, or their appropriate counterparts in radar systems which generate a plurality of range profile measurements for a given range and then combine the measurements to provide within-beam integration gain.

A problem with CFAR processing performed on data corresponding to returns from radar or similar systems (e.g lidar systems) is that detection of targets is difficult if they are within areas of high clutter return. In such cases the presence of high clutter returns results in a detection threshold which is too high, so that some targets are not detected.

It is an object of the present invention to ameliorate this problem.

According to the present invention, this object is achieved by a method of detecting a target in a scene, the method comprising the steps of
(a) obtaining a first data set of data elements which correspond to returns from different parts of the scene; and
(b) determining a detection threshold for a part of the scene by reference to data elements corresponding to returns from neighbouring parts of the scene;
   characterized in that
   (i) the method further comprises the steps of
(c) obtaining a second data set of data elements which correspond only to clutter returns from different parts of the scene; and
(d) identifying clutter returns in. the first data set by comparing the first and second data sets; and
   (ii) in step (b), data elements identified in step (d) as corresponding to clutter returns are discounted in determining the detection threshold.

The data sets may be obtained directly from a radar, lidar or similar system for use in the method (real-time processing). Alternatively, the data sets could be written to a storage system and then obtained therefrom for subsequent use in the method (off-line processing). By ignoring data elements corresponding to clutter returns in setting detection thresholds, targets close to buildings, trees, fences etc. are more reliably detected.

The method may be carried out using returns from an extended area of a scene, or alternatively using returns corresponding to a particular fixed direction. In the latter case, target detection may conveniently be performed by the steps of
(a) assigning the data elements to a linear array of contiguous range cells on the basis of range;
(b) determining a detection threshold for a part of the scene corresponding to a given range cell by reference to data elements assigned to the first and last n−1 cells of a reference group of 2n+1 cells (n≧2) centred on the given cell; and
(c) discounting data elements assigned to the first or last n−1 cells of the reference group if data elements corresponding to clutter returns are assigned to any of the first n−1 range cells in the reference group, or to any of the last n−1 range cells in the reference group, respectively.

In order to improve detection of small objects, data elements corresponding to a plurality of returns from an object may be combined to provide within-beam integration, for example using a Gaussian filter.

The data sets may be obtained by processing returns of a radar, lidar or similar system.

Corresponding to the above method of the invention, there is provided apparatus for detecting a target, the apparatus comprising means for generating and detecting returns from different parts of a scene and for generating signals corresponding to the returns, and processing means arranged to receive said signals and perform target detection thereon, characterized in that the processing means is arranged to execute the above method. The means for generating and detecting returns from objects and for generating signals corresponding to the returns is conveniently a radar or lidar system. The apparatus may further comprise a camera system, with the processing means being arranged to provide the camera system with positional information relating to the position of detected target, and the camera system being arranged to produce an image of the target upon receiving that information.

By repeated use of the above method, and recording the position of an object as a function of time, an improved target tracking function is provided. If, in addition, one or more parts of the scene are each associated with a pre-defined target behaviour, one or more warning signals may be generated if one or more detected and/or tracked targets conforms to a defined target behaviour with certain parts of the scene. In this way, inferences may be made regarding the intent of targets based on their trajectories.

In essence, the method of the present invention is a method of target detection involving the setting of a detection threshold for a part of a scene by reference to returns from neighbouring parts of the scene, but wherein returns corresponding to clutter are ignored in setting the threshold in order to provide improved target detection.

Embodiments of the invention are described below by way of example only and with reference to the accompanying drawings in which:

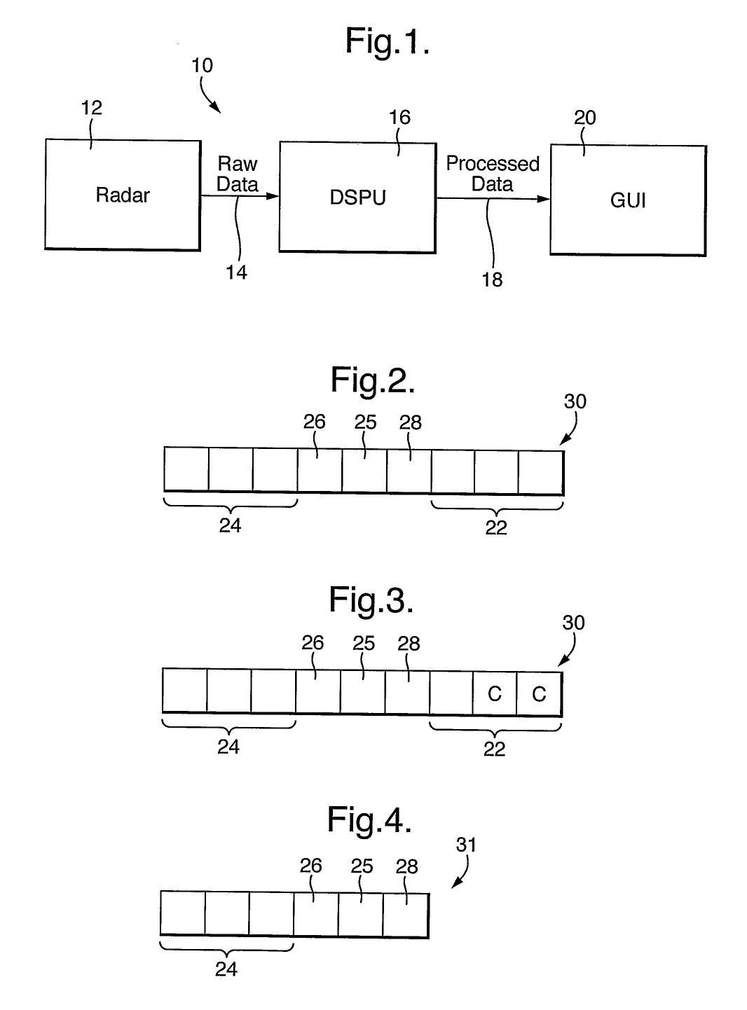

FIG. 1 is a block diagram of a radar system suitable for implementing a method of the present invention;

FIGS. 2 and 3 shows a default statistics window used to set detection thresholds in accordance with a method of the preset invention;

FIG. 4 shows a statistics window obtained by spatial adaptation of the FIG. 2 window in accordance with a method of the present invention; and

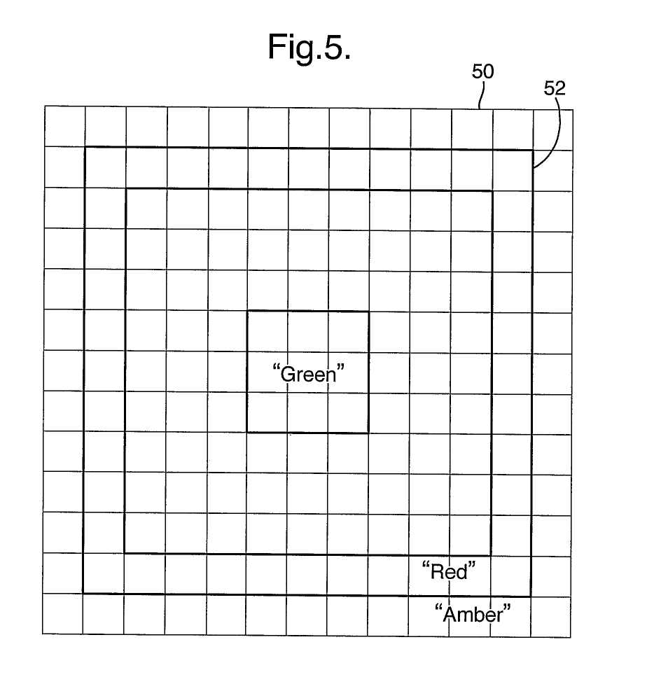

FIG. 5 illustrates extension of the functionality of a method of the present invention by visual programming.

In FIG. 1 a standard low-cost radar system 10 comprises a main radar unit 12, a DSP unit 16 and a computer 20 running a graphical user interface (GUI) for operating the system 10 and displaying information. Data from the main radar unit 12 is processed by an FFT algorithm to produce raw data which is then passed via a wireless ethernet link 14 to a DSP unit 16. Unit 16 is programmed to carry out a method of the present invention. Processed data is passed from the DSP unit 16 to the computer 20 for display by means of the GUI. The radar unit 12 has an antenna (not shown) set to fixed angular position so as to provide target detection in a fixed direction over a distance corresponding to the range of the unit 12. The beamwidth of the unit 12 is of the order of 1°. Its operating frequency is of the order of 10 GHz. The system 10 is arranged to have a sensitivity sufficient to detect walking and crawling persons within the radar beam. The antenna may be in a slightly elevated position with respect to the ground, or alternatively it may be arranged to look out horizontally. Range profile data generated by the system 10 is recorded within the DSP unit 16.

The system 10 operates to detect targets which are in the direction and beamwidth of the antenna as follows. Initially, range profile data is processed by the DSP unit 16 to build up a data set of clutter information (i.e. a clutter map) relating to stationary objects, such as trees and buildings, in the absence of targets. Data corresponding to the clutter information is passed to the computer 20 and individual data elements of the data are assigned to individual cells within a linear array of range cells according to the ranges of objects generating the returns to which the data elements correspond.

Further range profile data is generated and assigned to the range cells when the system 10 is operated to detect targets to produce a temporal series of data sets which are processed to identify targets. The processing used is CFAR processing, i.e. for each data set a detection threshold is set for each cell in the array such that target detection throughout the antenna beam is achieved with a constant false-alarm rate. For a particular data set, a detection threshold for each cell in the array is set as follows.

FIG. 2 shows a rectangular statistics window 30 consisting of 9 cells 22, 24, 25, 26, 28. The window 30 is moved along the linear array of range cells, and a detection threshold is set for a cell in the array coinciding with the central cell 25 of the window 30, by reference to data elements that have been assigned to cells corresponding to the first 24 three and last 22 three cells of the window 30.

Data corresponding to cells 26, 28 adjacent to the cell 25 under consideration is ignored to reduce the chance of data associated with a target within the cell 25 influencing the detection threshold. The data set corresponding to clutter information is compared to the data set under consideration. If none of the six cells 22, 24 correspond to regions of clutter return (identified by comparison with the clutter map), data from the six cells 24, 26 is used to calculate a detection threshold for the cell 25, based on an assumed clutter distribution.

FIG. 3 shows another possibility in which two of the cells 22 correspond to regions of high clutter return, as identified in the clutter map. In this case only data corresponding to the cells 24 is taken into account in calculating a detection threshold for the pixel 25. The window 30 is thus spatially adapted to form a window 31 (shown in FIG. 4) which covers only six cells.

The DSP unit 16 is thus programmed to spatially adapt the rectangular statistics window 30 in carrying out CFAR processing of data corresponding to each cell in the array so that regions of clutter return are ignored in calculating detection thresholds for each cell. In this way, the system 10 has a target detection efficiency and a false-alarm rate which are substantially constant over the whole region covered by the antenna beam.

To provide target detection over an area, the antenna of the radar unit 12 is scanned continuously through 360° to generate multiple data sets corresponding to returns from the area covered by the antenna beam in each scan. Data elements of each data set are assigned to a rectangular pixellated map, and CFAR processing carried out as described above on each pixel within the map. A two-dimensional statistics window is employed and pixels corresponding to clutter returns are not taken into account in determining detection thresholds for each pixel.

In the case of target detection over an area, the DSP unit 16 may be programmed to compare radar data corresponding to detected targets ever individual 360° angular scans of the monitored area in order to identify and track moving targets. A given detected radar return which appears at a particular pixel in a scan and which moves through adjacent pixels in subsequent scan s is identified as a moving target and positional information for the return is stored by the DSP unit 16 to provide a tracking function. If a detected target is tracked as moving in a straight line over a series a scans, a warning signal is passed to the computer 20 to display a visual warning on the GUI indicating that a moving intruder is present in the monitored area, a straight track generally indicating a human intruder with an intent to trespass, damage or steal property etc. If a plurality of moving targets is detected, the DSP unit 16 operates to establish the most deliberate track or tracks, providing for moving animals to be disregarded. The DSP unit 16 may also be programmed so that before a warning signal is output to the computer 20, the radar cross section (RCS) of the target is evaluated. In this way targets such as deer, cattle etc. may be ignored by placing constraints on the types of RCS that gives rise to warning signals.

The radar unit 12 may be arranged so that a number of range profile measurements are made with the antenna (or radar beam) in the same, or substantially the same, angular position. For example, if a 2° radar beam is scanned at 20°/s the beam will illuminate a point within the scan ambit for 1s. During this time a number of range profile measurements can be made and these can be subsequently integrated to provide within-beam integration gain.

The integration may be performed via some form of low pass filter such as a Gaussian filter. Filtering generates a set of range-angle measurements that are evenly sampled in angle, where the sample spacing is usually coarser than the raw measurement spacing. The filter is commensurate with the physical size and shape of the radar beam at the range processed and a Gaussian filter is typically suitable, although those skilled in the art may choose to vary the precise filter characteristics to suit a particular system.

The GUI operating on the computer 20 is arranged to allow visual programming of the program executed by the DSP unit 16 by a user so that warning signals are generated and displayed on the GUI if the behaviour of a target or targets conforms to certain user-defined rules. The system 10 is thus able not only to detect and track targets in the monitored area, but also to make certain logical conclusions based on target behaviour and to raise warnings if appropriate. An example of such visual programming of the system 10 is exemplified below, with reference to FIG. 5.

Referring to FIG. 5, a pixellated map corresponding to a square monitored area is indicated by 50. The map 50 is displayed on the GUI and is a 13×13 pixel array. The position of a closed fence within the monitored area is indicated on the map 50 by 52. Pixels lying between the position 52 of the fence and the outer edge of the monitored area may be designated by an operator of the system 10 as an “AMBER” zone by means of the GUI. Pixels of the map 50 lying immediately inside the position 52 of the fence may be designated as a “RED” zone by using the GUI. A portion of the monitored area corresponding to the central 3×3 pixels of the map 50 may be designated as a “GREEN” zone, this portion of the monitored area being known to be occupied by authorized stationary and moving targets.

The GUI interacts with the program executed by the DSP unit 16 so that appropriate alarms are raised in the following cases:
1. detection of a stationary or moving object in the amber zone (potential intruder seeking entry to fence-protected area)
2. detection of a stationary or moving object in the red zone (potential intruder has passed through or over the fence)
3. detection of a moving or stationary target in the amber zone, followed by detection of a stationary target in the red zone within a fixed subsequent period (potentially corresponding to an object being thrown over the fence).

Moving or stationary targets within the GREEN zone are ignored.

Although the foregoing relates to detection of targets using a millimetre-wave radar system, target detection and tracking according to the invention may also be carried out using microwave radar (operating for example at a frequency in the range 35 to 95 GHz) or lidar systems.

1. A method of dectecting a target in a scene, the method comprising the steps of
(a) obtaining a first data set of data elements which correspond to returns from different parts of the scene; and
(b) determining a detection threshold for a part of the scene by reference to data elements corresponding to returns from neighbouring parts of the scene; characterized in that
(i) the method further comprises the steps of
(c) obtaining a second data set of data elements which correspond only to clutter returns from different parts of the scene; and
(d) identifying clutter returns in the first data set by comparing the first and second data sets; and
(ii) in step (b), data elements identified in step (d) as corresponding to clutter returns are discounted in determining the detection threshold.

2. The method of claim 1 wherein the data elements correspond to returns from a given direction, and wherein the method comprises the steps of
(a) assigning the data elements to a linear array of contiguous range cells on the basis of range;
(b) determining a detection threshold for a part of the scene corresponding to a given range cell by reference to data elements assigned to the first and last n−1 cells of a reference group of 2n+1 cells (n >2) centred on the given cell; and
(c) discounting data elements assigned to the first or last n−1 cells of the reference group if data elements corresponding to clutter returns are assigned to any of the first n−1 range cells in the reference group, or to any of the last n−1 range cells in the reference group, respectively.

3. The method of claim 1 wherein data corresponding to a plurality of returns from an object is combined to provide within-beam integration gain.

4. The method of claim 3 wherein said data is combined using a Gaussian filter.

5. A method according to claim 1 wherein the data set comprises data from a radar or lidar system.

6. A computer program for performing a method according to claim 1.

7. A computer programmed to perform a method according to claim 1.

8. Apparatus (10) for detecting a target, the apparatus comprising means (12) for generating and detecting returns from different parts of a scene and for generating signals corresponding to the returns, and processing means (16) arranged to receive said signals and perform target detection thereon, characterized in that the processing means is arranged to execute a method according to claim 1.

9. The apparatus of claim 8 wherein the means for generating and detecting returns from objects and for generating signals corresponding to the returns is a radar or lidar system.

10. The apparatus of claim 8 further comprising a camera system and wherein the processing means is arranged to output data corresponding to the position of a detected target to the camera system, which is arranged to form an image of the object upon receiving said data.

11. A method of tracking a target comprising the steps of
(a) detecting and locating the target; and
(b) recording the target's location as a function of time characterized in that step (a) is performed by a method according to claim 1.

12. The method of claim 11 further comprising the steps of
(i) defining one or more target behaviours;
(iii) associating each target behaviour with a part of the scene; and
(ii) generating a warning signal if one or more detected targets conforms to a defined target behaviour associated with a part of the scene in which the target is detected and/or tracked.

13. The method of claim 12 comprising the steps of
(i) defining first and second parts of the scene;
(ii) generating a warning signal in the event that a moving object is detected in the first part of the scene and a stationary object is subsequently detected in the second part of the scene.

14. A computer program for performing a method according to claim 11.

15. A computer programmed to perform a method according to claim 11.

16. Apparatus (10) for tracking a target, the apparatus comprising means (12) for generating and detecting returns from objects in the area and for generating signals corresponding to the returns, processing means (16) arranged to receive said signals and perform target detection thereon and a data store for storing data corresponding to the position of a detected target as a function of time, characterized in that the processing means is arranged to execute a method according to claim 11.

17. The apparatus of claim 16 wherein the means for generating and detecting returns from objects in the area and for generating signals corresponding to the returns is a radar or lidar system.

18. The apparatus of claim 16 further comprising a camera system and wherein the processing means is arranged to output data corresponding to the position of a detected target to the camera system, which is arranged to form an image of the object upon receiving said data.
